(19) United States
(12) Patent Application Publication
(10) Pub. No.: US 2022/0126506 A1
(43) Pub. Date: Apr. 28, 2022

(54) SALIFIED MONOMER POWDER AND USE THEREOF IN A POWDER AGGLOMERATION PROCESS

(71) Applicant: Arkema France, Colombes (FR)

(72) Inventor: Geoffroy CAMMAGE, Serquigny (FR)

(73) Assignee: Arkema France, Colombes (FR)

(21) Appl. No.: 17/430,476

(22) PCT Filed: Feb. 13, 2020
(86) PCT No.: PCT/FR2020/050263

§ 371 Date: Aug. 12, 2021

(30) Foreign Application Priority Data
Feb. 13, 2019 (FR) 1901433

(51) Int. Cl. B29C 64/153; B33Y 80/00; B33Y 10/00; B33Y 70/00

(52) U.S. Cl. CPC B29C 64/153; B33Y 80/00; B29K 2077/00; B33Y 70/00; B33Y 10/00

(57) ABSTRACT

The use of at least one salified monomer powder in an additive manufacturing process. A process for the additive manufacture of an object wherein at least one salified monomer powder is used as raw material. A 3D printing product manufactured using at least one salified monomer powder. The salified monomer powder may have a volume median diameter D50 of less than or equal to 500 μm.

### FIELD OF THE INVENTION

The present invention relates to salified monomer powders and the use thereof in powder agglomeration processes.

### TECHNICAL BACKGROUND

The technology for agglomerating polyamide powders under electromagnetic radiation, such as a laser beam, is used to manufacture three-dimensional objects, such as prototypes and models, in particular in the motor vehicle, nautical, aeronautical, aerospace, medical (prostheses, auditory systems, cell tissues, and the like), textile, clothing, fashion, decorative, electronic casing, telephony, home automation, computing or lighting fields.

This technology also makes it possible to achieve fine and complex geometries, that are impossible to achieve by conventional molding techniques. In the case of laser sintering, a thin layer of polyamide powder is deposited on a horizontal plate maintained in a chamber heated to a temperature lying between the crystallization temperature Tc and the melting temperature Tm of the polyamide powder. The laser makes it possible to fuse the powder particles at various points of the layer which crystallizes slowly after the passage of the laser in a geometry corresponding to the object, for example using a computer that stores the shape of the 3D object and that reproduces this shape in the form of 2D slices. Subsequently, the horizontal plate is lowered by a value corresponding to the thickness of a powder layer (for example between 0.05 and 2 mm and generally of the order of 0.1 mm), then a new powder layer is deposited and the laser makes it possible to fuse powder particles in a geometry corresponding to this new layer which crystallizes slowly in a geometry corresponding to the object and so on. The procedure is repeated until the entire object has been manufactured. An object surrounded by powder is obtained inside the chamber. The parts which have not been agglomerated have thus remained in the powder state. After complete cooling, the object is separated from the powder, which can be reused for another operation.

However, several problems exist for additive manufacturing processes using polyamide powder. Indeed, the use of such polyamide powders leads to the presence of porosities on the manufactured parts and objects which may require treatment after their manufacture. Furthermore, the recycling of the unused polyamide powders is not always possible because a portion of the powder will often have evolved chemically and begun to agglomerate during the laser sintering process.

It is therefore necessary to provide raw materials, alternatives to polyamide powders, that are easier to manufacture and allow good cohesion of the material in the agglomeration processes.

### SUMMARY OF THE INVENTION

The present invention results from the unexpected demonstration, by the inventors, that a salified monomer powder, in particular a salified carboxylic acid and amine powder, can be obtained more easily in powder form than the corresponding polyamide and used directly as raw material in an agglomeration process. This salified monomer powder provides very good cohesion of the material compared to the usual powders.

Thus, the present invention relates to the use of at least one salified monomer powder in an additive manufacturing process.

The present invention also relates to a process for the additive manufacture of an object wherein at least one salified monomer powder as defined above is used as raw material.

The present invention also relates to a 3D printing product manufactured using at least one salified monomer powder as defined above.

### DETAILED DESCRIPTION OF THE INVENTION

In the present description of the invention, including in the examples below, the D50, also referred to as “volume median diameter”, corresponds to the value of the particle size which divides the population of particles examined exactly in two. The D50 is measured according to the standard ISO 9276—parts 1 to 6: “Representation of results of particle size analysis”. In the present description, a laser particle size analyzer (Sympatec Helos) and software (Fraunhofer) are used to obtain the particle size distribution of the powder and to deduce the D50 therefrom.

The analysis of the thermal characteristics of the polyamide is made by DSC according to the standard ISO 11357-3 “Plastics—Differential Scanning Calorimetry (DSC) Part 3: Determination of temperature and enthalpy of melting and crystallization”. The temperatures that more particularly concern the invention herein are the first-heat melting temperature (Tm1), the crystallization temperature (Tc) and the enthalpy of fusion.

### Salified Monomer Powder

The salified monomer powder according to the invention can be formed from at least one diamine and at least one dicarboxylic acid or at least one amino acid.

According to one embodiment, the salified monomer is a salt of at least one amino acid or a salt of at least one dicarboxylic acid and at least one diamine.

The monomer powder according to the invention can comprise two or more dicarboxylic acids. The dicarboxylic acid according to the invention can be aliphatic, aromatic or be a mixture of aliphatic and aromatic acid.

Preferably, the aromatic dicarboxylic acid according to the invention is selected from the group consisting of terephthalic acid, 2,6-naphthalenedicarboxylic acid, biphenyl-4,4′-dicarboxylic acid, isophthalic acid, naphthalenedicarboxylic acid, 5-hydroxyisophthalic acid, salts of 5-sulfoisophthalic acid, furandicarboxylic acid, or a combination thereof.

The aliphatic dicarboxylic acid according to the invention can be a non-cyclic, linear or branched dicarboxylic acid, or a cyclic dicarboxylic acid, or a combination thereof. The aliphatic dicarboxylic acid according to the invention can be an aliphatic dicarboxylic acid having 2 to 14 carbon atoms.

Preferably, the aliphatic dicarboxylic acid according to the invention is selected from the group consisting of oxalic acid, 1,4-butanedioic acid, 1,6-hexanedioic acid, cyclohexanedicarboxylic acid, 1,8-octanedioic acid, azelaic acid, sebacic acid, dodecanedioic acid, and tetradecanedioic acid, or a combination thereof.

In one embodiment of the invention, the carboxylic acid consists of:

(a) an aromatic dicarboxylic acid, and (b) optionally an aliphatic dicarboxylic acid, and (c) optionally another dicarboxylic acid.

The diamine according to the invention can consist of a mixture of two or more diamines. The diamine according to the invention can be aliphatic, arylaliphatic or a mixture thereof. Arylaliphatic diamines are diamines in which each of the amine groups is directly connected to an aliphatic moiety which aliphatic moieties are also connected to an aromatic moiety, such as m-xylenediamine and p-xylenediamine. The aliphatic diamine may comprise a linear aliphatic diamine, a branched aliphatic diamine or a cycloaliphatic diamine, or a combination thereof. The aliphatic diamine preferably comprises a diamine having from 2 to 15 carbon atoms. The C2-C15 aliphatic diamine is selected from the group consisting of 1,2-ethylenediamine, 1,3-propanediamine, 1,4-butanediamine, piperazine, 1,5-pentanediamine, 1,6-hexanediamine, methyl-1,5-pentanediamine, 1,2-cyclohexanediamine, 1,3-cyclohexanediamine, 1,4-cyclohexanediamine, 1,7-heptanediamine, 1,8-octanediamine, 1,3-bis(aminomethyl)cyclohexane, 1,9-nonanediamine, trimethylhexanedia mine, 1,10-decanediamine 1,11-undecanediamine, 1,12-dodecanediamine, 4,4′-methylenebis(dicyclohexylamine), 3,3′-dimethyl-4,4′-diaminodicyclohexylmethane, p-phenylenediamine, m-xylylenediamine and p-xylylenediamine or a combination thereof.

Preferably, the diamine comprises a C4-C10 linear diamine, more particularly 1,4-butanediamine, 1,5-pentanediamine, methyl-1,5-pentanediamine, 1,6-hexanediamine, 1,4-cyclohexanediamine, 1,3-bis(aminomethyl)cyclohexane and 1,10-decanediamine, or a combination thereof.

In one embodiment of the invention, the salified monomer powder comprises at least one amino acid such as 11-aminoundecanoic acid, 12-aminododecanoic acid, N-heptylaminoundecanoic acid. Preferably, the amino acid is 11-aminoundecanoic acid.

The salified monomer powder according to the invention comprising at least one dicarboxylic acid and at least one diamine, or at least one amino acid also referred to as an “ammonium carboxylate salt”.

The salified monomer powder according to the invention is preferably obtained by bringing a dicarboxylic acid into contact with a diamine or from an amino acid. The salified monomer powder according to the invention is preferably the result of the neutralization reaction between the dicarboxylic acid and the diamine.

Preferably, the ammonium carboxylate salt is formed by impregnating a diamine with a dicarboxylic acid powder. Preferably, the carboxylic acid powder is stirred at a temperature below or equal to the melting temperature of the dicarboxylic acid. Also preferably, the carboxylic acid powder is stirred at a temperature below the melting temperature of the salt and above or equal to the melting temperature of the diamine.

Preferably, the reaction temperature is 40° C. below the melting temperature of the ammonium carboxylate salt, more preferably 60° C. below the melting temperature of the ammonium carboxylate salt.

Preferably, the reaction temperature is below 220° C., preferably between 100° C. and 210° C., more preferably between 130° C. and 150° C. The reaction temperature may also be between 0° C. and 20° C.

Preferably, the melting point of the dicarboxylic acid used in the present invention is above 100° C.

Preferably, the melting point of the diamine used in the present invention is between 25° C. and 200° C.

The stirring of the dicarboxylic acid powder can be carried out by any means well known to those skilled in the art such as mechanical stirring or gas flow stirring.

The diamine can be added to the dicarboxylic acid powder by any means known to those skilled in the art. For example, the diamine can be added to the dicarboxylic acid powder by spraying or dripping the diamine into the stirred dicarboxylic acid powder. Preferably, the diamine is added gradually to the dicarboxylic acid powder.

Preferably, the rate of addition of the diamine is from 0.07% to 6.7% by mass per minute relative to the total amount of the diamine to be added.

The reaction can be carried out in the presence of water. Preferably, the amount of water is between 1% and 10% by mass relative to the total amount of dicarboxylic acid powder and of diamine. More preferably, the amount of water is less than or equal to 5% by mass relative to the total amount of the dicarboxylic acid powder and of a diamine. The water can be removed by evaporation during the formation of the salt. A chain limiter or a polymerization catalyst can be added to the dicarboxylic acid and diamine powder. The term “chain limiter” is understood to mean an agent capable of blocking the end of the terminal functional groups of a polymer. Examples of such a terminal blocking agent include acetic acid, lauric acid, benzoic acid, octylamine, cyclohexylamine and aniline. Preferably, the chain limiter is added in an amount of 5 mol % or less relative to the total number of moles of the dicarboxylic acid powder and the diamine.

Examples of polymerization catalysts include phosphoric acid, phosphorous acid, hypophosphorous acid and the salts of these acids. The amount of the polymerization catalyst used is preferably 2 mol % or less relative to the total number of moles of the dicarboxylic acid powder and the diamine.

Additives can also be added to the powder of diamine and dicarboxylic acid salt according to the present invention at any stage of the production of the salt. As examples of such additives, mention may be made of a filler or a stabilizer, pigments, dyes, carbon black, carbon nanotubes, antioxidants, UV stabilizers, or else plasticizers. The amount of additive(s) used is preferably 20% by mass or less relative to the total mass of the dicarboxylic acid powder and the diamine.

Preferably, the volume median diameter D50 of the particles of the salified monomer powder (also referred to as “ammonium carboxylate salt”) according to the invention is less than or equal to 500 μm. Preferably, the volume median diameter D50 of the particles of the salified monomer powder (also referred to as “ammonium carboxylate salt”) is between 5 μm and 250 μm. Also preferably, the volume median diameter D50 of the particles of the salified monomer powder (also referred to as “ammonium carboxylate salt”) is between 30 μm and 80 μm.

Examples of polyamides that can be obtained by polymerization of the monomer salt powder according to the invention include:
PA 11: Polyundecanamide manufactured from 11-aminoundecanoic acid;
PA 12: Polylauroamide manufactured from 12-aminododecanoic acid;
PA 4.6: polytetramethylene adipamide, manufactured from 1,4-butanediamine and adipic acid;
PA 6.6: polyhexamethylene adipamide, manufactured from hexamethylenediamine and adipic acid;
PA 6.9: polyhexamethylene nonanediamide, manufactured from hexamethylenediamine and 1,9-nonanedioic acid;
PA 6.10: polyhexamethylene sebacamide manufactured from hexamethylenediamine and sebacic acid;
PA 6.12: polyhexamethylene dodecanediamide, manufactured from hexamethylenediamine and 1,12-dodecanedioic acid;
PA 10.10: Polydecamethylene sebacamide manufactured from decanediamine and sebacic acid;
PA 10.12: Polydecamethylene sebacamide manufactured from decanediamine and 1,12-dodecanedioic acid;
PA 6.T: manufactured from 1,6-hexanediamine and terephthalic acid;
PA 4.T/6.T: manufactured from 1,4-butanediamine, 1,6-hexanediamine and terephthalic acid;
PA 6.T/10.T: manufactured from 1,6-hexanediamine, 1,10-decanediamine and terephthalic acid;
PA 4.T/10.T: manufactured from 1,4-butanediamine, 1,10-decanediamine and terephthalic acid;
PA 6.6/6.T: manufactured from hexamethylenediamine, adipic acid, 1,6-hexanediamine and terephthalic acid;
PA 4.T/DACH.T: manufactured from trans-1,4-diaminocyclohexane, 1,4-butanediamine and terephthalic acid;
PA MXD.6: manufactured from m-xylenediamine and adipic acid;
PA MXD.10: manufactured from m-xylenediamine and sebacic acid;
PA BMACM.10: manufactured from bis(3-methyl-4-aminocyclohexyl)methane and sebacic acid;
PA PACM.12: manufactured from p-aminocyclohexylmethane and dodecanedioic acid.

### Use

The invention relates to the use of the salified monomer powder according to the invention in an additive manufacturing process. An additive manufacturing process is understood to mean a process for manufacturing an object by agglomeration of the salified monomer powder.

The use of the salified monomer powder according to the invention in an agglomeration technology is particularly advantageous because it provides very good cohesion of the material compared to the usual powders.

The salified monomer powders according to the invention can be used within the context of the process for manufacturing objects by melting caused by a laser beam (laser sintering), IR radiation or UV radiation. The laser sintering technique is described in particular in patent application EP1571173.

In addition, the salified monomer powder according to the invention can also be used in composites, substrate coatings, transfer papers or to manufacture cosmetic compositions.

### Additive Manufacturing Process

The invention also relates to a process for manufacturing objects by agglomeration of salified monomer powder according to the invention. Preferably, the salified monomer powder according to the invention is placed in a chamber heated to a temperature below or equal to the melting temperature of the salified monomer powder.

Preferably, the temperature of the chamber is between 110° C. and 175° C., more preferably, the temperature of the chamber is between 130° C. and 175° C. Even more preferably, the temperature of the chamber is between 150° C. and 175° C.

The process for manufacturing an object by agglomeration of salified monomer powder according to the invention comprises a step of polymerizing the salified monomer powder. The process for manufacturing an object by agglomeration of salified monomer powder according to the invention further comprises a step of 3D construction. Preferably, the step of polymerizing the salified monomer powder and the step of 3D construction are carried out simultaneously.

Preferably, the polymerization continues in the melt state as well as in the solid state during the remainder of the construction.

The invention also relates to a process for manufacturing an object by agglomeration of the salified monomer powder according to the invention during which:

a. a thin layer of salified monomer powder according to the invention (layer 1) is deposited on a horizontal plate maintained in a chamber heated to a temperature below the melting temperature of the salified monomer powder;

b. the salified monomer powder (layer 1) is melted, polymerized and agglomerated simultaneously in a geometry corresponding to the object to be manufactured, using a laser;

c. the horizontal plate is lowered by a value corresponding to the thickness of a layer of salified monomer powder according to the invention then a new layer of salified monomer powder according to the invention is deposited (layer 2);

d. the salified monomer powder layer (layer 2) is melted, polymerized and agglomerated simultaneously in a geometry corresponding to this new slice of the object to be manufactured;

e. the horizontal plate is lowered by a value corresponding to the thickness of a layer of salified monomer powder according to the invention then a new layer of salified monomer powder (layer 3) according to the invention is deposited;

f. the salified monomer powder layer (layer 3) is melted, polymerized and agglomerated simultaneously in a geometry corresponding to this new slice of the object to be manufactured;

g. the previous steps are repeated until the object is completed;

h. the chamber is cooled, preferably slowly.

After complete cooling, the object and the powder are separated. In one embodiment of the invention, the salified monomer powder which has not been used is recovered and reused for another operation.

According to another aspect, the present invention relates to a 3D printing product manufactured according to the additive manufacturing process as defined above.

The invention will be further explained in a nonlimiting manner with the aid of the following example.

### EXAMPLE

The properties of a salified monomer powder according to the invention are studied in a powder agglomeration process.

### 1. Salified Monomer Powder

A salified 11-aminoundecanoic acid powder (commercial product sold by Arkema), with a volume median diameter D50 of the particles of 50 μm, is used.

### 2. Use

The powder is used in an LS machine using temperatures in the working and build chamber below 175° C. so as not to melt the powder but above 150° C. to promote polymerization even after the passage of the laser.

Good quality parts are obtained.

1. The use of at least one salified monomer powder in an additive manufacturing process.

2. The use as claimed in claim 1, wherein the salified monomer powder has a volume median diameter D50 of less than or equal to 500 μm.

3. The use as claimed in claim 1, wherein the salified monomer powder has a volume median diameter D50 of between 5 μm and 250 μm.

4. The use as claimed in claim 1, wherein the salified monomer is a salt of at least one amino acid or a salt of at least one dicarboxylic acid and at least one diamine.

5. The use as claimed in claim 4, wherein the amino acid is 11-aminoundecanoic acid or 12-aminododecanoic acid.

6. The use as claimed in claim 4, wherein the dicarboxylic acid is selected from the group consisting of terephthalic acid, 2,6-naphthalenedicarboxylic acid, biphenyl-4,4′-dicarboxylic acid, isophthalic acid, naphthalenedicarboxylic acid, oxalic acid, 1,4-butanedioic acid, 1,6-hexanedioic acid, 1,8-octanedioic acid, cyclohexanedicarboxylic acid, sebacic acid, azelaic acid, dodecanedioic acid, and tetradecanedioic acid and cyclohexanedicarboxylic acid, or a combination thereof.

7. The use as claimed in claim 4, wherein the diamine is selected from the group consisting of 1,2-ethylenediamine, 1,3-propanediamine, 1,4-butanediamine, 1,5-pentanediamine, 1,6-hexanediamine and 1,4-cyclohexanediamine, 1,7-heptanediamine, 1,8-octanediamine, 1,9-nonanediamine, 1,10-decanediamine, 1,11-undecanediamine, 1,12-dodecanediamine, p-phenylenediamine, m-xylylenediamine and p-xylylenediamine, or a combination thereof.

8. A process for the additive manufacture of an object wherein at least one salified monomer powder as defined in claim 1 is used as raw material.

9. The process as claimed in claim 8, wherein the salified monomer powder is placed in a chamber heated to a temperature below or equal to the melting temperature of the salified monomer powder.

10. The process as claimed in claim 8, wherein the salified monomer powder is placed in a chamber heated to a temperature between 150° C. and 175° C.

11. The process as claimed in claim 8, comprising a step of polymerizing the salified monomer powder.

12. The process as claimed in claim 11, further comprising a step of 3D construction.

13. The process as claimed in claim 12, wherein the step of polymerizing the salified monomer powder and the step of 3D construction are carried out simultaneously.

14. The process as claimed in claim 8, wherein once the object is manufactured, it is separated from the salified monomer powder which is recovered and reused in a process for the additive manufacture of an object.

15. A 3D printing product manufactured using at least one salified monomer powder as defined in claim 1.

16. The 3D printing product as claimed in claim 15.

17. A 3D printing product manufactured according to the additive manufacturing process as defined in claim 8.
